(19) United States
(12) Patent Application Publication
(10) Pub. No.: US 2004/0268079 A1
(43) Pub. Date: Dec. 30, 2004

(54) Method and system for providing a secure rapid restore backup of a raid system

(75) Inventors: Linda A. Riedle, Cary, NC (US); David B. Rhoades, Raleigh, NC (US)

Correspondence Address: SAWYER LAW GROUP LLP, PO BOX 51418, PALO ALTO, CA, 94303, US

(73) Assignee: International Business Machines Corporation, Armonk, NY

(21) Appl. No.: 10/602,317

(22) Filed: Jun. 24, 2003

(51) Int. Cl. G06F 12/14

(52) U.S. Cl. 711/173; 711/162; 711/163; 711/112; 711/114; 711/164

(57) ABSTRACT

A method and system for providing a secure data storage system is disclosed. The secure data storage system includes a processor and a disk drive system that is partitioned into one or more logical partitions. A backup partition is also created, which is hidden from the processor and used to back up the logical partitions. On system reboot, the low-level physical drive write commands are automatically blocked, thereby preventing a virus from making use of the physical drive write commands to destroy data on the logical partitions and the backup partition.

### FIELD OF THE INVENTION

The present invention relates to data storage systems that are capable of creating a hidden backup partition, and more particularly to a data storage system that effectively protects the hidden backup partition from a virus attack.

### BACKGROUND OF THE INVENTION

Storage systems that partition one or more storage devices (e.g., hard disk drives) into logical drives that divide the physical drives into logical components to protect a user's data are well known. For example, U.S. Pat. No. 6,324,627 discloses a virtual data storage (VDS) system for use with a computer system. The VDS system includes one or more physical disk drives and a VDS controller coupled between the disk drive and a CPU. The VDS controller partitions the disk drive into multiple virtual disk drives. During normal computer operation, the VDS controller presents only some of the virtual disk drives to the operating system executing on the CPU, and prevents the CPU from accessing the remaining virtual disk drives.

The VDS system enables a computer system that is periodically used by different users to provide each user with their own virtual disk drive, which can be accessed only when that user's operating the computer system. Thus, any corruption or destruction of data, by a virus for example, that occurs while a particular user is operating the computer system can occur only to data or programs stored in the portion of the physical disk drive corresponding to that user's virtual disk drive.

The VDS controller performs the virtual disk drive configuration during the computer system's boot sequence. During the boot sequence, the VDS controller displays a configuration menu to enable the user to select a new disk drive configuration, or to select and activate an existing virtual disk drive configuration. The generation of a new virtual disk drive configuration and the activation of the virtual disk drives that have been selected by the user are password protected. After the choices have been made, the virtual disk drive configuration is stored on the disk drive.

During the computer system's normal operation, the virtual disk drive configuration is not accessible by the computer system, or any operating system program or application program being run by the computer system. To implement this, the VDS controller includes a one-time-writable register in which data necessary to implement the virtual disk drive configuration are written to only once after the computer system is reset or powered up, and thereafter cannot be written to again.

Although the VDS system may prevent corruption of information stored in a particular virtual disk drive, the system has several disadvantages. One disadvantage is that although the VDS system limits a virus attack only to the currently accessible logical disk drive, there is no provision for backing up and restoring the logical disk drive after the attack. For example, assume that there are two users, A and B, that use two different logical disk drives on the computer system. The VDS system will prevent a virus that attacks user A's virtual disk drive from affecting user B's virtual disk drive, but no protection is provided and a backup is not maintained to protect user A's data. Furthermore, if the users share a common logical disk drive for shared applications, there is nothing in the VDS system that protects the shared drive from a virus or to provide a backup.

Another disadvantage is that no provision is made to block low-level physical drive commands that can perform a format unit operation, which removes all disk data. A further disadvantage of the VDS system is that it only allows a user to configure and hide a logical disk drive during system boot. This places unnecessary limitations on the computer system and prevents virtual disk drive configuration by program control instead of by a user logon prompt.

Accordingly, what is needed is an improved data storage system that is capable of backing up stored data in a manner that protects both the logical disk drives and the backup data from a virus attack. The present invention addresses such a need.

### SUMMARY OF THE INVENTION

The present invention provides a secure data storage system. The secure data storage system is accessed by a processor and a disk drive system that is partitioned into one or more logical partitions. A backup partition is also created, which is hidden from the processor and used to back up the logical partitions. On system reboot, low-level physical drive write commands are automatically blocked, thereby preventing a virus from making use of the physical drive write commands to destroy data on the logical partitions and the backup partition.

### BRIEF DESCRIPTION OF THE DRAWINGS

FIG. 1 is a high-level block diagram illustrating a secure data storage system in accordance with a preferred embodiment of the present invention.

FIG. 2 is a flow chart illustrating a process the RAID controller performs for protecting a hidden backup partition from a virus attack in accordance with a preferred embodiment of the present invention.

FIG. 3 is a flow diagram illustrating the process of restoring a corrupted logical partition.

### DETAILED DESCRIPTION OF THE INVENTION

The present invention relates to a storage system that creates and hides a logical partition for use as data backup and a method for protecting the hidden partition from a virus. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides a computer system with a secure data storage system that backs up stored data in a manner that protects the backup data from a virus attack and that uses the backup data to restore the storage system in the event of lost data. The physical storage devices are partitioned into logical partitions and a backup partition. The data from the logical partitions are copied to the backup partition, and the backup partition is hidden from the computer system. On system boot, low-level physical drive write commands are automatically blocked, thereby preventing a virus from making use of the physical write commands to destroy the data on the physical drives.

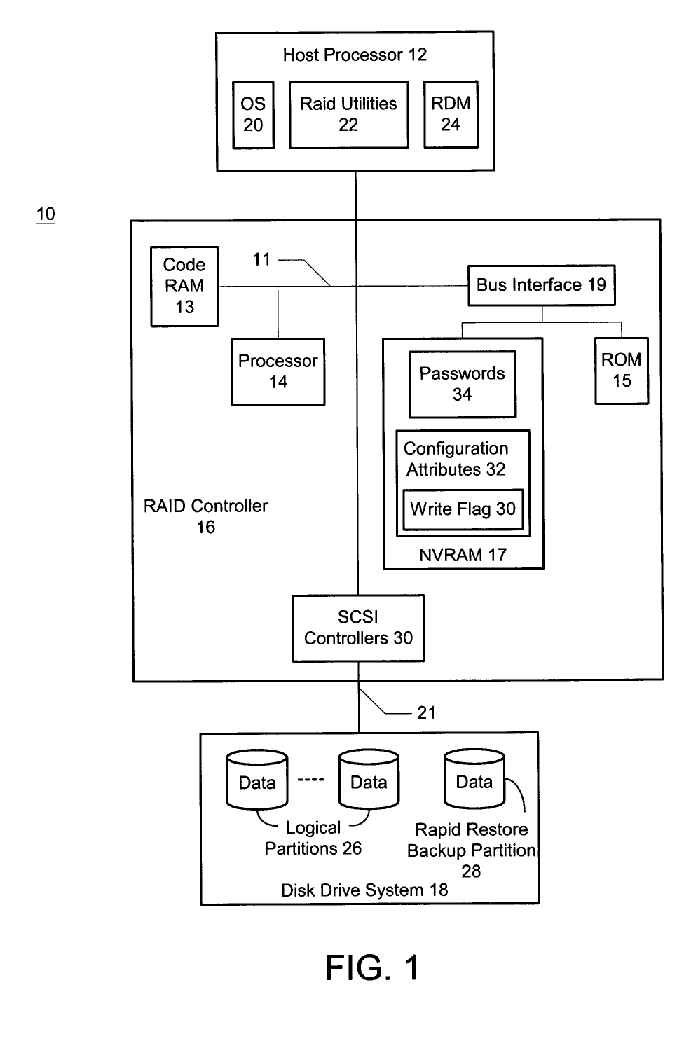

FIG. 1 is a high-level block diagram illustrating a secure data storage system in accordance with a preferred embodiment. The present invention will be described in terms of a storage system comprising Redundant Arrays of Inexpensive Disks (RAID). However, the principles disclosed herein may be applied to any type of storage device or devices.

As depicted, RAID data storage system 10 includes a raid controller 16 coupled between a host 12, typically via PCI/PCI bus adapter (not shown), and a disk drive system 18. The RAID controller 16 and host processor 12 may be incorporated in a single data processing system hardware unit, such as a general-purpose digital computer (not shown). Alternatively, RAID controller 16 may be incorporated into one data processing system hardware unit and host processor 12 may be incorporated into another data processing system hardware unit, such as the general-purpose digital computer.

The RAID controller 16 includes a processor 14 that controls data storage. Processor 14 is preferably a microprocessor and is coupled to processor bus 11. Also coupled to a processor bus 11 is code/data RAM 13, which is utilized to temporarily store code and data utilized by processor 14. ROM 15 and non-volatile random access memory (NVRAM) 17 are coupled to the processor bus 11 through a bus interface 19. NVRAM 17 is typically a low power CMOS memory that is powered up for “back-up” by a battery such that the information stored in NVRAM 17 will not be lost when main power is terminated. Thus, NVRAM 17 may be utilized to store configuration attributes 32 or operational code in a manner similar to that stored within ROM 15.

The RAID controller 16 is coupled to the disk drive system 18 by a local bus 21. Also coupled to the local bus 21 are one or more small computer system interface (SCSI) control chips 30 for supporting the disk drive system 18. Hard disk arrays comprising the disk drive system 18 are preferably divided into logical components, referred to as logical drives or partitions 26, which may be viewed by the host 12 as separate drives. Each logical partition 26 includes a cross section of each of the physical drives. For example, if the RAID storage system 10 includes ten physical drives in the array, and is accessible by four users, then the physical drives will be divided into at least four logical partitions 26 where each user has access to one of the logical partitions 26.

The RAID controller 16 may be a hardware and/or software tool for providing an interface between the host processor 12 and the disk drive system 18. Preferably, the RAID controller 16 manages the disk drive system 18 for storage and retrieval and can view the disks of the RAID separately. The disks included in the array may be any type of data storage systems that can be controlled by the RAID controller 16 when grouped in an array.

Host processor 12 executes software, such as an operating system 20, RAID utilities 22, Remote Deployment Manager (RDM) software 24, and other application programs (not shown). In a preferred embodiment, the RDM software 24 is a configuration and maintenance utility that includes commands for allowing an administrator to instruct the RAID controller 16 to create the logical partitions 26 on the disk drive system 18. The RDM software 24 also instructs the RAID controller 16 to create an additional backup partition, referred to herein as a rapid restore partition 28. Once data from the logical partitions 26 is backed up to the rapid restore partition 28, the RAID controller 16 hides the rapid restore partition 28 from the host processor 12. If a user inadvertently destroys the data on one or more of the logical partitions 26, the user is able to boot the storage system 10 using the RDM software 24 from a diskette or CD-ROM and restore the data from the rapid restore partition 28.

Although the RDM software 24 is effective for correcting inadvertent user mistakes, the RDM software 24 by itself does not protect the rapid restore partition 28 from some types of virus attacks. That is, the system 10 would be protected from a virus that attacks the logical partitions by issuing a low-level operating system write command to the partition 28 because the RAID controller 16 hides the rapid restore partition 28 from the host processor 12. Therefore, a “device not found” type of error would be returned if the virus did issue such a command.

The RDM software 24 by itself, however, does not protect the logical partitions 26 and the rapid restore partition 28 if a virus issued a low-level physical drive command, such as format commands that affect the physical drives, rather than logical partitions. An example of such a physical drive command is a direct Control Data Block (CDB) write command, which writes to sectors on a disk. Overwriting the sectors on which the partitions 26 and 28 are stored would destroy the partitions 26 and 28.

In accordance with the present invention, the RAID storage system 10 is modified to prevent such an attack as follows. In a preferred embodiment of the present invention, the RAID controller 16 is provided with a write flag 30 to block and unblock low-level physical drive write commands. The flag 30 defaults to a block setting at system 10 reboot. In a preferred embodiment, the flag 30 is stored as part of the RAID configuration attributes 32 within the NVRAM 17.

The RAID utilities 22 (and any other program) that utilize the low-level physical drive write commands are modified to send block/unblock write commands to the RAID controller 16. Before issuing a low-level write command, the RAID utilities 22 issue an unblock write command to the RAID controller 16 to unblock the low-level physical drive write commands. Upon completion of the low-level write command, the RAID utilities 22 issue a block write command to the RAID controller 16 to re-block the low-level write command.

In addition, the RAID utilities 22 and any program utilizing the low-level physical drive write commands are password-protected, as are the hide/unhide logical partition commands in the RDM software 24. The RAID utilities 22 include a GUI and/or a command line interface that prompt the user to set/enter their password at the time the utility 22 needs to send the write command. In a preferred embodiment, the user passwords 34 are stored in the NVRAM 17, which is difficult for a virus to hack from the host processor 12. Also, in a preferred embodiment, the password entered by the user at the prompt of one of the RAID utilities 22 is passed to the RAID controller 16 as part of the contents of the block/unblock command and the hide/unhide logical partition command.

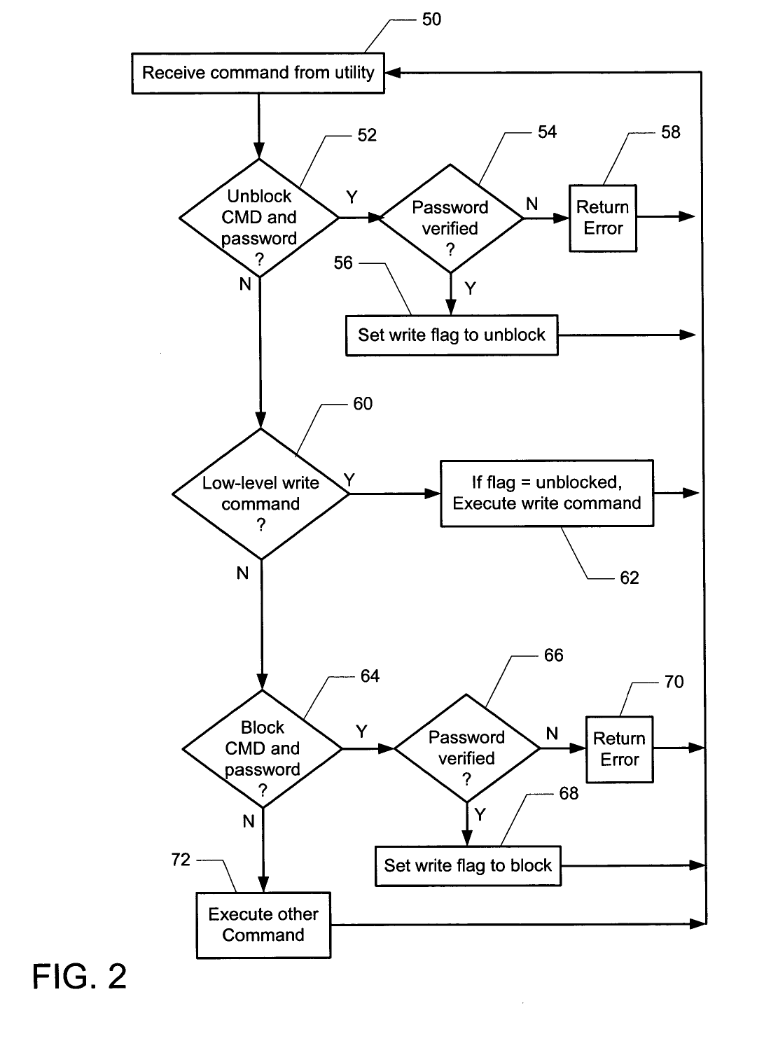

FIG. 2 is a flow chart illustrating a process the RAID controller 16 performs for protecting the partitions 26 and 28 from a virus attack in accordance with a preferred embodiment of the present invention. The process assumes that the system 10 has been booted normally and that the block/unblock write flag 30 is set to block. The process further assumes that a RAID utility 22 (or other program) is invoked that needs to issue a low-level write command, and that the utility 22, in turn, has prompted the user for a password.

The process begins in step 50 when the RAID controller 16 receives a command from a RAID utility 22. If the RAID controller 16 receives an unblock command and password in step 52, then the RAID controller 16 attempts to verify the password in step 54 by comparing the password to the user's stored password 34. If the passwords match, then the RAID controller 16 sets the write flag 30 to unblock in step 56. If the passwords do not match, then the RAID controller 16 returns an error in step 58.

If the RAID controller 16 subsequently receives a low-level write command in step 60, then the RAID controller 16 in step 62 verifies that the write flag 30 is set to unblock and executes the write command.

If the RAID controller 16 then receives a block command and password in step 64, then the RAID controller 16 attempts to verify the password in step 66 by comparing the password to the user's stored password 34. If the passwords match, then the RAID controller 16 sets the write flag 30 to block in step 68. If the passwords do not match, then the RAID controller 16 returns an error in step 70. Any other commands are processed via step 72.

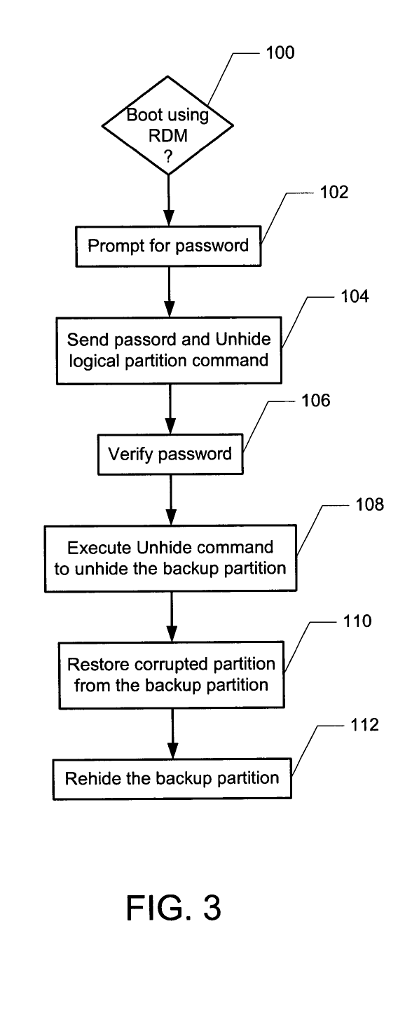

FIG. 3 is a flow diagram illustrating the process of restoring a corrupted logical partition 26. After a logical partition 26 has been corrupted, the user may boot the system 10 using the RDM software 24 in step 100. In response, the RDM software 24 prompts the user for a password in step 102. In step 104, RDM software 24 sends the password and a command to unhide the rapid restore partition 28 to the RAID controller 16. In step 106, the RAID controller 16 verifies the password, and then unhides the rapid restore partition in step 108. In step 110, the corrupted logical partition 26 is restored from the rapid restore partition 28. In step 112, the rapid restore partition 28 is re-hidden, the write flag is set to block, and the raid storage system 10 begins normal operation.

The present invention maintains a backup image of the operating disk drive system 18 on a locked and hidden logical partition 28. This logical partition is used to save the captured image in order to restore the system using the captured image. The present invention uses the block/unblock write flag 30 to prevent low-level commands, such as a RAID direct CDB write command, from destroying the hidden logical partition 28. Through the use of the block/unblock write flag 30 and the password protection, the present invention enables both users and programs to access and alter configuration attributes 32 of the backup partition 28 and the RAID controller 16 during normal operation versus only at boot time, while maintaining security of the system 10. In addition, because the decision-making of what to enable is made at the RAID controller level and not in the system BIOS, hacking the BIOS will not gain one access to the hidden logical partitions.

A method and system for providing a secure data storage system has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1 A method for providing a secure data storage system, wherein the data storage system is accessed by a processor, the method comprising the steps of:
(a) creating a plurality of logical partitions;
(b) creating a backup partition and backing up the logical partitions to the backup partition;
(c) hiding the backup partition from the processor; and
(d) automatically blocking low-level physical drive write commands, thereby preventing a virus from using such a command to destroy data on the logical and backup partitions.

2 The method of claim 1 further including the step of providing the data storage system as a RAID system wherein a RAID controller is coupled between the processor and a disk drive system containing the logical partitions and the backup partition.

3 The method of claim 1 wherein step (d) further includes the step of: providing the RAID controller with a write flag to block and unblock the low-level physical drive write commands, and defaulting the write flag to a block setting at system reboot.

4 The method of claim 3 wherein step (d) further includes the step of:
requiring a utility that utilizes the low-level physical drive write commands to first issue an unblock write command to the RAID controller prior to issuing a low-level physical drive write command in order to set the write flag to unblock; and
upon completion of the low-level physical drive write command, requiring the utility to issue a block write command to the RAID controller to re-block the low-level write command by setting the write flag to block.

5 The method of claim 4 wherein step (d) further includes the steps of: password protecting the block/unblock write command issued by the utility.

6 The method of claim 5 wherein step (d) further includes the step of: enabling backup partition configuration by both a user and program control during normal operation.

7 The method of claim 6 wherein step (d) further includes the step of: passing a password entered by a user at a prompt of the utility to the RAID controller with the block/unblock command.

8 The method of claim 3 wherein step (d) further includes the step of: storing the write flag as part of the RAID configuration attributes within the RAID controller.

9 The method of claim 5 wherein step (d) further includes the step of: storing the write flag and a user password for the block/unblock write command in an NVRAM.

10 The method of claim 1 further including the steps of: using a software utility to enable a user to create the logical partitions and a backup partition, and to use a hide/unhide logical partition command to hide and unhide the backup partition.

11 The method of claim 10 further including the step of: password protecting the hide/unhide logical partition command.

12 The method of claim 11 further including the step of: storing the password for the hide/unhide logical partition command in an NVRAM.

13 The method of claim 10 further including the steps of:
(e) after one or more of the logical partitions has been corrupted, allowing a user to boot the system using the utility software;
(f) sending a user entered password and the unhide logical partition command to the RAID controller, and unhiding the backup partition if the password is verified; and
(g) restoring the corrupted logical partition from the backup partition.

14 A data storage system comprising,
a processor for executing programs;
a disk drive system divided into logical partitions and a backup partition, the backup partition for backing up the logical partitions, and wherein the backup partition is hidden from the processor; and
a controller coupled between the processor and the disk drive system, the controller including a write flag for blocking and unblocking physical drive write commands, wherein the write flag defaults to a block setting at system reboot and is configurable during normal system operation by a program executing on the processor via a user password-protected block/unblock command.

15 The system of claim 14 wherein a utility that utilizes the low-level physical drive write commands first issues an unblock write command to the RAID controller prior to issuing a low-level physical drive write command in order to set the write flag to unblock, and upon completion of the low-level physical drive write command, issues a block write command to the RAID controller to re-block the low-level write command by setting the write flag to block.

16 The system of claim 15 wherein the block/unblock write command issued by the utility is password protected.

17 The system of claim 16 wherein a password entered by a user at a prompt of the utility is passed to the RAID controller with the block/unblock command.

18 The system of claim 17 wherein the write flag is stored as part of the RAID configuration attributes within the RAID controller.

19 The system of claim 18 wherein the write flag and a user password for the block/unblock write command is stored in an NVRAM.

20 The system of claim 14 further including a software utility to enable a user to create the logical partitions and the backup partition, and to use a hide/unhide logical partition command to hide and unhide the backup partition.

21 The system of claim 20 wherein the hide/unhide logical partition command is password protected.

22 The system of claim 21 wherein the password for the hide/unhide logical partition command is stored in an NVRAM.

23 The system of claim 20 wherein after one or more of the logical partitions has been corrupted, the user boots the system using the utility software, the user entered password and the unhide logical partition command is sent to the RAID controller, the backup partition is unhidden if the password is verified, and the corrupted logical partition is restored from the backup partition.

24 A computer-readable medium containing programs instructions for providing a secure data storage system, wherein the data storage system is accessed by a processor, the instructions for:
(a) creating a plurality of logical partitions;
(b) creating a backup partition and backing up the logical partitions to the backup partition;
(c) hiding the backup partition from the processor; and
(d) automatically blocking low-level physical drive write commands, thereby preventing a virus from using such a command to destroy data on the logical and backup partitions.

25 The computer-readable medium of claim 24 further including the instruction of providing the data storage system as a RAID system wherein a RAID controller is coupled between the processor and a disk drive system containing the logical partitions and the backup partition.

26 The computer-readable medium of claim 24 wherein instruction (d) further includes the instruction of: providing the RAID controller with a write flag to block and unblock the low-level physical drive write commands, and defaulting the write flag to a block setting at system reboot.

27 The computer-readable medium of claim 26 wherein instruction (d) further includes the instruction of:
requiring a utility that utilizes the low-level physical drive write commands to first issue an unblock write command to the RAID controller prior to issuing a low-level physical drive write command in order to set the write flag to unblock; and
upon completion of the low-level physical drive write command, requiring the utility to issue a block write command to the RAID controller to re-block the low-level write command by setting the write flag to block.

28 The computer-readable medium of claim 27 wherein instruction (d) further includes the instructions of: password protecting the block/unblock write command issued by the utility.

29 The computer-readable medium of claim 28 wherein instruction (d) further includes the instruction of: enabling backup partition configuration by both a user and program control during normal operation.

30 The computer-readable medium of claim 29 wherein instruction (d) further includes the instruction of: passing a password entered by a user at a prompt of the RAID utility to the RAID controller with the block/unblock command.

31 The computer-readable medium of claim 26 wherein instruction (d) further includes the instruction of: storing the write flag as part of the RAID configuration attributes within the RAID controller.

32 The computer-readable medium of claim 28 wherein instruction (d) further includes the instruction of: storing the write flag and a user password for the block/unblock write commands in an NVRAM.

33 The computer-readable medium of claim 24 further including the instructions of: using a software utility to enable a user to create the logical partitions and a backup partition, and to use a hide/unhide logical partition command to hide and unhide the backup partition.

34 The computer-readable medium of claim 33 further including the instruction of: password protecting the hide/unhide logical partition command.

35 The computer-readable medium of claim 34 further including the instruction of: storing the password for the hide/unhide logical partition command in an NVRAM.

36 The computer-readable medium of claim 33 further including the steps of:
(e) after one or more of the logical partitions has been corrupted, allowing a user to boot the system using the utility software;
(f) sending a user entered password and the unhide logical partition command to the RAID controller, and unhiding the backup partition if the password is verified; and
(h) restoring the corrupted logical partition from the backup partition.
